(19) United States
(12) Patent Application Publication
(10) Pub. No.: US 2009/0269003 A1
(43) Pub. Date: Oct. 29, 2009

(54) FIBRE OPTIC SWEAT SENSOR

(76) Inventors: Patricia Jane Scully, Derbyshire (GB); John Vaughan, Derbyshire (GB)

Correspondence Address: UNILEVER PATENT GROUP, 800 SYLVAN AVENUE, AG West S. Wing, ENGLEWOOD CLIFFS, NJ, 07632-3100, US

(21) Appl. No.: 12/310,082

(22) PCT Filed: Jul. 30, 2007
(86) PCT No.: PCT/EP2007/057830

§ 371 Date: Feb. 9, 2009

(30) Foreign Application Priority Data
Aug. 10, 2006 (GB) 0615901.6
Jan. 15, 2007 (GB) 0700693.5

(51) Int. Cl. G02B 6/00; B05D 5/00

(52) U.S. Cl. 385/12; 427/2.12

(57) ABSTRACT

A sensor for sweat or other aqueous discharge onto skin comprises a plastic optical fibre comprising a core and cladding, said core being in intimate contact at a first end with a light emitter and at a second end with a light detector, and said fibre having a sensing zone in which the cladding is replaced by a water-permeable translucent biocompatible polymer containing dispersed therein a biocompatible indicator that varies the intensity of an optical signal at a selected wavelength depending on whether the indicator is wet or dry. Such a sensor permits real time monitoring of sweating or other discharge, and can also enable electronic recording and/or remote monitoring.

The present invention relates to an optical fibre sensor and to a method employing such a sensor to detect sweat or other aqueous fluids seeping from skin

Humans perspire and an industry has grown in many countries of the world to create products for inhibiting or controlling sweating in localised parts of the body, such as in particular in the underarm, so as to prevent the appearances of wet patches on skin itself or in water-absorbent clothing that comes into contact with skin. In order to develop such products, it is necessary for the industry to be able to measure the effectiveness of the ingredients and resultant compositions at inhibiting sweating.

Commonly, sweating is measured by a gravimetric method in which panellists hold an absorbent pad, commonly made from cotton, in the axilla for a predetermined period of time, often from 20 to 40 minutes, whilst seated in a room having controlled temperature and high humidity conditions. The pad is weighed before and after contact with the panellist and the effectiveness of a product is determined by comparing pads from left and right axilla, to one of which an antiperspirant composition had been topically applied and to the other either a reference composition or no composition had been applied. Whilst this method has been practised by the industry for over 50 years, it suffers from a number of disadvantages. First, the method requires dedicated rooms to be built, requiring capital investment. Secondly, the method measures the accumulation of sweat over a period of time rather than in direct response to any event that triggers perspiration, be it exercise or emotional. Thirdly, the method is not readily amenable to continuous monitoring, on-line monitoring, or remote data collection. Fourthly, the current method does not identify closely the onset of sweating.

In the course of their research, the instant inventors have identifies a means that overcomes one or more of the disadvantages of the current method employed for sweat detection.

In order to identify when sweating or the like is occurring, it is necessary to be able to differentiate between high relative humidity in the vicinity of the sensor and liquid water in contact with the sensor. Optical fibre sensors have previously been disclosed for the detection of humidity, for example, the doping of a polymethyl-methacrylate optical fibre with a fluorescing dye. However, in such sensors, the doping reaction occurs at the surface of the polymer and is ionic. The fluorescence created by the dye when contacted with water vapour can be detected, so that the sensor functions to indicate humidity, and indeed can even differentiate between low and high humidity. However, such a humidity detector is not able to distinguish between a humid atmosphere for example around 85% relative humidity (RH) and the conditions in the vicinity of sweat, in which droplet formation occurs, conditions of extremely high RH of over 92 or 93% RH up to 100% RH. Thus, a sensor system that has been proposed for detecting humidity cannot be assumed to be applicable to detecting sweat and even if an investigator had as an objective identifying a sensor suitable for monitoring sweating, no indication is given as to what would necessary to achieve that objective or worse still whether it is even possible to achieve that objective.

Humidity detectors are normally employed in the environment and thus are not adapted or disposed for use in personal care applications, such as would be necessary in detecting sweating. Accordingly, detectors for humidity hitherto identified also suffer from one or more disadvantages that render them unsuitable directly for personal care applications or are otherwise inferior.

In U.S. Pat. No. 4,851,817 and U.S. Pat. No. 5,005,005, there is disclosed a method of roughening an exposed surface of an optical fibre to act as a detector. Roughening is an inferior method because of lack of reproducibility and it also constrains options, in that it would similarly affect light of both longer and shorter wavelengths.

EP 146522A and U.S. Pat. No. 4,749,856 disclose a system for moisture detection in the environment. The system disclosed is an extrinsic device comprising a polymer attached to two fibres, a system that is mechanically incompatible with creating a sensor for sweat.

EP 335128A discloses a plasma polymerised hexamethyldisiloxane and ammonia to act as a moisture sensing active. This is another extrinsic device.

In U.S. Pat. No. 6,582,658, there is disclosed a sensor comprising a super-absorbing polymer hosting cobalt chloride. This is suitable for use in the environment, but not in personal care applications because cobalt chloride is toxic.

In both U.S. Pat. No. 5,319,975 and U.S. Pat. No. 5,440,927, there is disclosed a sensor comprising a selected hydrophilic polymer, polyvinylalcohol, as host polymer for a fluorescer. The sensor, as disclosed, employs a framework that prevents contact between the sensor surface and skin, were it to be contemplated for use in a personal care application. Furthermore, as indicated above, whilst its fluorescence can indicate humidity, it is silent about the region of extremely high humidity and accordingly provides no teaching about the invention of a sweat sensor that needs to be able to differentiate between high humidity and conditions in which droplet formation occurs.

In WO 9852022, there is disclosed a sensor having a head that is not designed for contact with skin, as is necessary for a personal application.

In JP 06-011448 (Kokai), there is disclosed a humidity sensor that employs cobalt chloride as indicator. As indicated hereinabove, this is not suitable for a personal care application because the compound is toxic.

In JP 10-319253 (Kokai), there is disclosed a humidity sensor that employs Rhodamine B as indicator. This indicator is not suitable for a personal care application because the compound is not biocompatible. Moreover, the sharp, pointed shape of the sensing zone renders it inappropriate for contact with skin, for example in the underarm.

In JP 20040228285, there is disclosed a sensor comprising an absorbent layer on a quartz crystal for human secretions which selectively absorbs organic nitrogenous compounds or cholesterol, fatty acid, lactic acid or glucose and detects their presence by attenuated total reflection in the infra red. The disclosure does not foreshadow the detection of the onset or termination of sweating using primarily evanescent field attenuation.

In U.S. Pat. No. 4,834,497, there is disclosed a method of for example sensing toxic or explosive gasses or measuring ground water contamination employing a cladding that absorbs a fluid and exhibits a change in an optical property. The general disclosures therein do not direct the reader towards selecting a method for detecting the onset or termination of sweating employing evanescent field attenuation.

EP 251475 discloses a method and apparatus for monitoring glucose by comparing fluorescence emissions from a conjugate comprising active glucose oxidase and a fluorescence dye immobilised on a solid support with solely the fluorescence dye on a solid support. There is no teaching that directs the reader towards selecting a method of detecting the onset or termination of sweating and in particular one that is based on evanescent field attenuation.

EP 253559 discloses a sensor for measuring the concentration of a gaseous component in a fluid, such as CO₂, employing an infra-red signal that varies in intensity in relation directly to that gaseous component itself. It does not even direct the reader to employ an indicator that interacts with a liquid material to identify the onset or termination of sweating.

EP 36017 discloses a method of analysing a test fluid to determine the concentration of a solute therein by illumination with e.g. light of a wavelength that is selectively absorbed by the analyte. It does not direct the reader to identify a method for detecting the presence of the fluid itself.

Whilst many of the above-identified disclosures indicate techniques for identifying or measuring a solute, be it a dissolved gas, glucose or otherwise, and even in a bodily fluid, they do not address the problem of distinguishing between high humidity in which water remains in its gaseous phase and the onset (or subsequent termination) of sweating when water is now in a liquid phase.

### BRIEF SUMMARY OF THE PRESENT INVENTION

According to one aspect of the present invention, there is provided a sensor for detecting sweat according to claim 1. The extent of attenuation, viz reduction in the intensity of light detected by the light detector, differs between, on the one hand, dry conditions, when there is no liquid phase in the sensing zone of the sensor and the water is present in the form of vapour, and, on the other hand, wet conditions, i.e. when a liquid phase is present.

Likewise, such a sensor can be employed, if desired, to detect other aqueous fluid that is discharged onto skin from a body.

In a related second aspect of the present invention there is provided a method of detecting sweat or other discharged aqueous fluid onto the skin surface employing a sensor in accordance with the first aspect that is brought into intimate contact with an appropriate area of the body.

A third aspect of the present invention comprises a process for the manufacture of a sensor in accordance with the first aspect in which in a sensing zone a plastic optical fibre free from cladding is coated with a water-permeable translucent polymer in which is distributed an indicator that is sensitive to water in droplet form, i.e. liquid as contrasted with gaseous water (humidity).

A sensor in accordance with the present invention advantageously can be portable and worn safely by the user during his day to day activities. By the employment of a sensor in accordance with the first aspect, it is possible to monitor in a “real time” manner sweating and like fluid discharge events. Such a sensor also enables the contemplation of detecting sweat and the like in the real world, by which is meant detection outside the confines of a dedicated temperature and/or humidity controlled sweat room. Furthermore additionally or alternatively, such a sensor enables ready storage of real-time data regarding sweating or the like in electronic format, and/or remote monitoring of such data via electronic data transmission from the sensor or a collection device to a remote receiving station.

In a related fourth aspect of the invention there is provided a system for monitoring sweating or other aqueous discharge onto skin surface which employs a sensor according to the first aspect and additionally a means for recording observations on the user of the sensor, thereby enabling a comparison to be made between monitored discharge, such as sweat, and the activity of the user.

The sensor, preferably as part of the system in the third aspect, can be employed in order to identify formulations or ingredients therein that are well suited to control or reduce sweating or other aqueous discharges, and particularly by comparison with a reference formulation.

The invention is applicable not only to identify a correlation between physical activity and sweating or other discharge, but in relation to sweating, can more accurately and temporally correlate sweating with emotional or other stimuli.

### MORE DETAILED DESCRIPTION AND PREFERRED EMBODIMENTS

The present invention relates to a sensor in which light of a suitable wavelength is conveyed along an optical fibre from an emitter to a detector, passing through a water-permeable zone in which an indicator is dispersed. The indicator is water-sensitive, by which is meant that the intensity of light of a predetermined wavelength that exits from the zone varies dependent on whether the indicator is wet or dry.

The instant invention can be described as evanescent field sensing or alternatively evanescent field attenuation. Advantageously, a sensitive water-permeable zone is created by cladding the optical fibre core in an interrupted manner with a cladding which prevents light from leaking out of the fibre or ingress into it, thereby leaving a length that is exposed (bare) or subsequently removing a length of the cladding from the optical fibre core, thereby exposing bare fibre core. Thereafter, an indicator is dispersed in a water-permeable translucent polymer and applied to the exposed fibre core. Both the polymer and the indicator satisfy the term “biocompatible” which indicates that material is not toxic nor causes immunological rejection. Moreover, herein, the term biocompatible applies not only to the material itself, but any solvent employed in the manufacture of the material or the dispersion of the indicator in the polymer and remaining in the polymer when the sensor is in use. For the avoidance of doubt, this excludes from employment in the invention sensor sensitive bio-incompatible materials like cobalt chloride which is toxic and reportedly killed beer drinkers during the 1960s in view of its use to stabilise foam.

The optical fibre core is most conveniently an organic polymeric optical fibre (commonly abbreviated to POF), and most suitably polymethylmethacrylate. A further polymeric material that can be contemplated as the core comprises polycarbonate. The diameter of the optical fibre core is preferably selected in the range of from 0.05 to 2 mm, in many desirable embodiments being at least 0.1 mm and advantageously at least 0.2 mm. It is particularly convenient to employ a core having a diameter in of from 0.5 to 1.5 mm, such as from 0.9 to 1.1 mm. A balance is often struck herein between the flexibility of the fibre core and its capacity to transmit light, such as resulting in selection of a diameter of from 0.75 to 1.25 mm. The cladding of the optical fibre core is conveniently a cladding material having a refractive index differing from the core sufficiently for light passing along the core to be reflected at the interface between core and cladding. For polymethylmethacrylate core fibre, a conventional cladding comprises fluorinated polymethylmethacrylate. The cladding typically comprises a thin film around and adhering to the core, commonly having a thickness of from 5 to 20 μm, such as 8 to 12 μm. Clad polymethylmethacrylate fibre is commercially available.

In some suitable embodiments of the present invention, the water-permeable polymer (host polymer) in contact with the optical fibre core in its sensing zone is water-soluble at body temperature, such as in the range of 36 to 38° C., e.g. 37° C. The sensor employing such a host polymer is well suited to detecting the onset of sweating, for example in determining whether some external event or activity conducted by the wearer of the sensor results in sweating, and/or how long afterwards. This is unlike the conventional gravimetric method of sweat detection in which a volume of sweat is gathered over for example 30 minutes and does not relate the overall sweating to any particular event or activity.

In other and advantageous embodiments of the present invention, the water-permeable host polymer in contact with the optical fibre in its sensing zone is advantageously water-insoluble at body temperature, such as in the range of 36 to 38° C., such as a solubility at 37° C. of not greater than 1% w/v. This property enables the sensor to remain in contact with skin on which sweat or other aqueous liquid will discharge over an extended period of time during which monitoring can occur. Such monitoring can advantageously be at the discretion of those carrying out monitoring (subject of course to the consent of the person being monitored). Unlike the conventional gravimetric method of measuring sweat or like discharges, the period of monitoring can be longer than the typical sweat room stay of between 30 minutes and an hour, for example longer than an hour, often at least 2 hours, possibly as long as 24 hours or from 4 to 8 or 12 hours. Extended monitoring can be achieved, for example by changing the optical fibre from time to time. A particularly suitable means to achieve extended monitoring comprises an immobilised indicator in a water-insoluble host polymer such a polymer or copolymer of HEMA. The capability of extended monitoring is a further benefit compared with convention sweat-room based methods.

It is particularly desirable to select a polymer to act as host for the indicator that has refractive index that is reasonably close to that of the optical fibre core, e.g. polymethylmethacrylate. Conveniently, the difference in RI is not greater than 0.1 units, such as not greater than 0.05 units, at 25° C. The refractive index of candidate host polymers is often included in manufacturers' data sheets or alternatively can be measured using a refractometer in a conventional manner by comparison with a range of standard materials of known RI at 25° C.

Very desirably, the selection of a hydrophilic host polymer enables it to be readily water-permeable and to enable water to interact with the dispersed indicator.

It is advantageous to select a polymer to act as host for the indicator that is resistant to abrasion, either when dry or when wet, and preferably both when dry and wet. By so doing, the life of the sensor can be prolonged.

Furthermore, especially when contemplating a core fibre of polymethylmethacrylate, it is desirable to select a host polymer that can conveniently be cured at a temperature that does not exceed 85° C.

One class of suitable host polymers comprises polyvinylalcohol, conveniently having an average molecular weight (weight average) of from 75000 to 200000 daltons. Further suitable host polymers to act as a translucent carrier for the indicator include gelatine, alginin, and chitosan. A yet further desirable host polymer is methylcellulose, such as having a weight average molecular weight of from 25000 to 60000 daltons, e.g. around 40000 daltons. An alternative class of host polymers worthy of particular attention comprises poly(2-hydroxyethyl-methacrylate), abbreviated to p(HEMA), possibly copolymerised with an alkylmethacrylate such as ethylmethacrylate viz (EMA) or methylmethacrylate viz (MMA) or MMA/ethyl acrylate viz (EA), and particularly copolymers with an intermediate mole fraction of the alkylacrylate such as around 20 to 33% or 40%. A host copolymer of HEMA and MMA in a monomer ratio of about 2:1 is especially desirable. Hydroxyacrylate/alkylacrylate copolymers, including in particular p(HEMA-co-MMA) are advantageously cross linked, for example using an aminoalkylethoxysilane.

The thickness of the host polymer is commonly at least 5 μm and in many embodiments is not greater than 40 μm. Its thickness is preferably from 7 to 25 μm. Such a thickness for the host polymer is well suited to providing a rapid response time for the sensor to respond to sweat or like fluid coming into contact with the exterior surface of the host polymer and is likewise well suited to the sensor drying out quickly when sweating has ceased, thereby enabling the sensor to enjoy a rapid recovery time before being ready to detect a subsequent onset of sweating.

A water-soluble host polymer can conveniently be applied by dissolution in water for example to form a solution having a concentration of from 2 to 20% by weight of polymer therein, and often from 4 to 10% by weight, at a temperature of from ambient up to about 95° C., depending on the solubility characteristics of the polymer, preferably causing or allowing the solution to cool to a temperature of not higher than 85° C., and especially not higher than 80° C., dipping the exposed fibre core into the solution and removing the wetted core and allowing or causing evaporation of the aqueous solvent. This deposits a film of the host polymer around the core. An alternative solvent comprises ethanol which can be substituted for all or a fraction of water to form the solution of the host. An ethanol-based solvent is preferred for application of HEMA copolymers. It can be expedient to repeat the dipping and drying cycle to build up a deposition of a desired thickness, for example up to 6 cycles.

A suitable indicator comprises fluorescein. This has the benefit of responding differently to light in the region of 450 to 540 nm (i.e. attenuating the light to a different extent) when wet compared with when it is dry or when exposed to a humid atmosphere, even of high humidity, such as around 85% RH. In particular, the instant research has shown a significant difference in the intensity of light leaving the sensing zone when the fluorescein has been wetted (occurring at 92% to 100% relative humidity that is generated by sweat) compared with even 85% relative humidity. The difference in intensity is readily observed at wavelength of about 470 nm, blue light, (e.g. peak intensity in the range of 465 to 475 nm) which is of practical benefit since light of such a wavelength can be generated using commercially available light emitting diodes. In some embodiments, fluorescein is employed in acid form and in other embodiments as the sodium salt. Sodium fluorescein is a very convenient form. Such forms of fluorescein are comparatively easy to incorporate in a host polymer and are particularly convenient to employ when comparatively short sweat monitoring sessions. An alternative that can be contemplated comprises fluorescein isothiocyanate. This alternative is particularly suitable for employment within a cross-linked polymer in that it can be entrapped therein, resisting leaching by sweat. Accordingly, it is very suitable for comparatively long sweat monitoring sessions, such as any at or exceeding 4 hours. Fluorescein isothiocyanate/crosslinked p(HEMA-co-MMA) copolymer beneficially demonstrates an especially rapid response to the commencement or termination of sweating.

Fluorescein/sodium fluorescein can exist in a number of different species, depending on deprotonation extent. These species are cationic, neutral, anionic or dianionic. The variation in the proportion of different fluorescein species causes an increase absorption of blue light with an increase in humidity until water droplets are formed, reducing absorption, but concurrently, increased fluorescence and transmission occurs as the polymer swells and fills with water molecules.

The selection of light with a peak intensity in a narrow range centring on 470 nm, e.g. 465 to 475 nm, for employment with a fluorescein indicator is particularly advantageous for a detection method based on evanescent field attenuation. It has been observed in practice that although fluorescence from fluorescein could, in theory, occur at a wavelength of about 516 nm, the trace of detected light intensity against wavelength showed no detectable shoulder at 516 nm. That indicates that, at the low concentration of fluorescein employed, a concentration that was capable of demonstrating clearly the onset (or termination) of sweating using evanescent field attenuation, no significant fluorescence was detected, so that fluorescence detection was incapable of providing the desired demonstration.

The indicator is distributed through the host polymer. The mode of distribution of the indicator is at the discretion of the sensor manufacturer and will often take into account the nature of both the host polymer and the indicator. In some preferable instances, the indicator is incorporated into the host before the host is applied to the exposed core optical fibre and cured. In other instances, the host polymer is applied to the optical fibre core, and the indicator is doped into the host, for example by dissolution in a solvent that is removed subsequently, for example by evaporation at an elevated temperature, such as in the range of 50 to 80° C., and/or in a stream of gas such as dry air or an non-reactive gas such as nitrogen. Bio-compatible solvents that can be readily removed include acetone, low boiling point chlorocarbons, such as carbon tetrachloride and chloroform, and hydrocarbons such as toluene or benzene.

The indicator can commonly be employed at a low concentration, for example in the range of from 1 part per 2000 to 1 part per 100 by weight in the host polymer. A preferred range is from 2 parts per 3000 up to 1 part per 500 by weight.

Although it is possible to employ a sensor that emits solely light in the above-identified range at which the indicator is sensitive, such as blue light, particularly with a peak intensity in the region of 465 to 475 nm, in the case of fluorescein, and thereafter detect the attenuated intensity of light at that wavelength, it is preferable to include a comparison second signal at a different wavelength, namely one that does not show such a significant change in intensity between when the indicator in the sensing zone is dry or wet. In the case of fluorescein, it is especially desirable to employ light having a wavelength of over 600 nm, e.g. red light of wavelength 625 nm, as the reference. Such light can readily be generated by commercially available light emitting diodes. Comparison of the intensity of the sensitive and the reference light generates a ratio which changes significantly when the indicator is wetted, thereby enabling the clear and unmistakable identification of sweat generation. In the instance of using fluorescein, the ratio increases when the indicator is wetted. The employment of such a reference means is of particular value in providing dynamic sensing.

It can be contemplated to employ two substantially parallel optical fibres that have substantially the same sensing zone, the sensitive light being conducted through one fibre and the reference light through the other. Alternatively, and very preferably, the sensor employs a single optical fibre through which both lights are conducted alternately.

The detection is apparent when only a small volume of sweat or other aqueous fluid has been captured by the host polymer, so that the onset of sweating is detected with little delay. This is much more rapid than in a conventional gravimetric method. Moreover, when sweating ceases, the sweat evaporates out of the host polymer quickly, enabling it to be ready to detect a subsequent sweating event, an option that is not really practical during the gravimetric method, or at best is very inconvenient.

The emitter can conveniently be a light emitting diode (LED), selected to emit light of the desired wavelength. When the sensor employs two lights of different wavelengths, (peak wavelengths) sensitive light and reference light, it is possible to employ two different emitters, connected to the optical fibre, for example using a y coupler. Advantageously, the emitter is capable of generating and emitting at least two spaced wavelengths, such as light with peak intensity in the region of 470 nm and light in the region of 625 or 650 nm, the one being sensitive light and the other being reference light in apparatus disclosed herein.

The detector for light comprises most conveniently a photodiode. Whilst it is possible to contemplate two photodiodes, the one tuned to the sensitive light and the other to the reference light, if both lights are employed, it is especially desirable to employ a broad spectrum photodiode, one that is capable of detecting both lights. A broad spectrum photodiode not only simplifies the sensor, but also makes it smaller, thereby assisting its portability. Such photodiodes are commercially available. The electronic output from the detector or detectors can be manipulated by the microprocessor, stored in an electronic memory and/or displayed on a suitable screen, for example in graphical or digital format under control of the microprocessor.

In practice, a portable sweat detector comprises a control unit coupled with an optical fibre having a sensing zone as described hereinbefore, the control unit housing a light emitter positioned and adapted to emit light of a selected wavelength along the optical fibre, a detector positioned an adapted to collect light from the end of the optical fibre remote from the end into which light is emitted, a power source and control means to control when light is emitted. Desirably, the control unit additionally includes a display means and/or a memory. The unit can be programmed to store or transmit raw data, such as outputs from the detector at selected wavelength or wavelengths, and readings of background intensity, or/and the output from which background intensity had been deducted or/and the calculated ratio of output intensities at two wavelengths less background intensities.

Firing of the LED to emit a sensitive light or sensitive and reference light alternately can most conveniently be under the control, usually, of a microprocessor. Most conveniently, the control unit housing the microprocessor includes start/stop controls. The microprocessor can additionally comprise an electronic memory for storing the output for the detector(s) and the unit can optionally further include a transmitter to transmit data on command to a remote receiver. To improve portability of the sensor, the transmitter may have a limited range, for example to a relay station in a personal computer. The microprocessor herein can, in some embodiments, conveniently be integrated with other functions, and would then be commonly referred to as a micro-controller. The memory from a portable sensor may be removable from the sensor control unit and inserted into a transmitter, once again assisting the portability of the sensor. Alternatively, the control unit can be provided with a port such as a USB port to allow data transfer to a portable memory or an external computer. The power source is often a low voltage battery such as intended for a watch or electronic calculator, cell-phone or like devices. The battery conveniently can be a commercially available low voltage rechargeable battery, such as a lithium ion battery.

The sensor may employ, in some embodiments, an optical fibre permanently fixed to the control unit, enabling the detector to be disposable. In other embodiments, the optical fibre may comprise a mounting, enabling it to be detachably mounted proximal to the emitter and detector, and the control unit locating means, enabling the fibre to be replaced by a fresh optical fibre, as and when it reaches the end of its useful life, thereby prolonging the life of the sensor.

The invention sensor described herein is particularly suited for detecting sweat, be it in the underarm or elsewhere on the body, particularly of humans. It can alternatively be employed to monitor weeping wounds or other aqueous seepages from the body.

In at least some advantageous embodiments, the sensor further comprises attachment means for detachably securing the sensor for example the unit housing the sensor to skin, and particularly to secure the sensing zone in intimate contact with an area of the body such as the axilla in which detection of aqueous discharge is desired. Such attachment means can comprise adhesive tape with a protective cover that is removed prior to use to expose an adhesive surface for contact with skin. Other attachment means such as straps, which may be elasticated or include fasteners can alternatively or additionally be contemplated to secure the sensor to for example an arm in the vicinity of the axilla. Alternatively, the sensor can be attached to or incorporated in a garment, for example in a sleeve, possibly tightly fitting, to bring the sensor into contact with skin such as in the axilla. The control unit from which the sensor optical fibre extends to the underarm, or sensors to both underarms, can conveniently be held in a pouch or like holder on a belt worn around the waist.

The control unit or monitoring system can optionally incorporate known sensors of ambient physical conditions, e.g. of temperature or/and humidity in a controlled or real world environment, as well as a clock, to enable the onset or cessation of sweating and ambient physical conditions to be correlated.

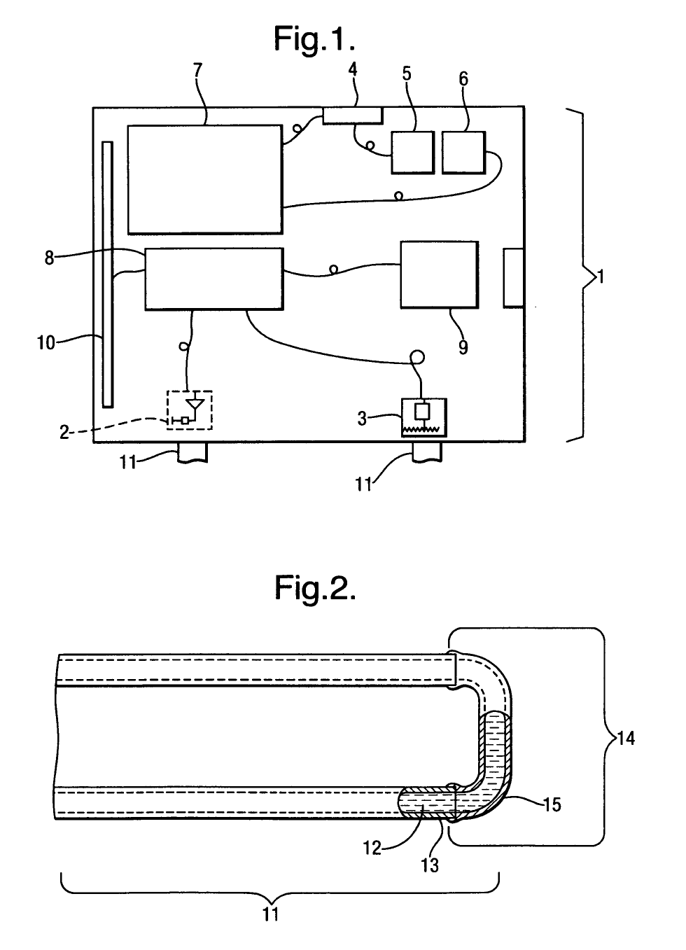

Having described preferred embodiments of the instant invention, specific embodiments will now be described in more detail by way of example only and with reference to FIGS. 1 to 8.

FIG. 1 represents a schematic diagram of s sweat sensor control unit equipped for twin light emission and detection;

FIG. 2 represents a part cross sectional view of an optical fibre for attachment to the control unit of FIG. 1;

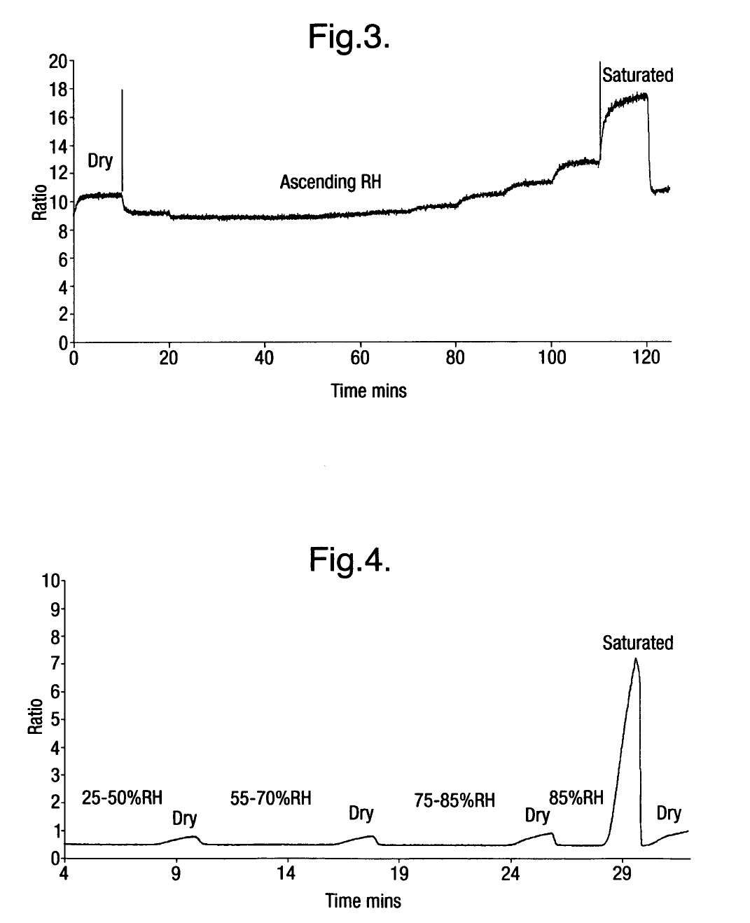

FIG. 3 represents a graph of the ratio of intensity variation of blue to red light measured employing fluorescein as indicator in methylcellulose as host polymer in the sensing zone of the optical fibre according to FIG. 2;

FIG. 4 represents a graph of the ratio of intensity variation of blue to red light measured employing fluorescein as indicator in chitosan as host polymer in the sensing zone of the optical fibre according to FIG. 2;

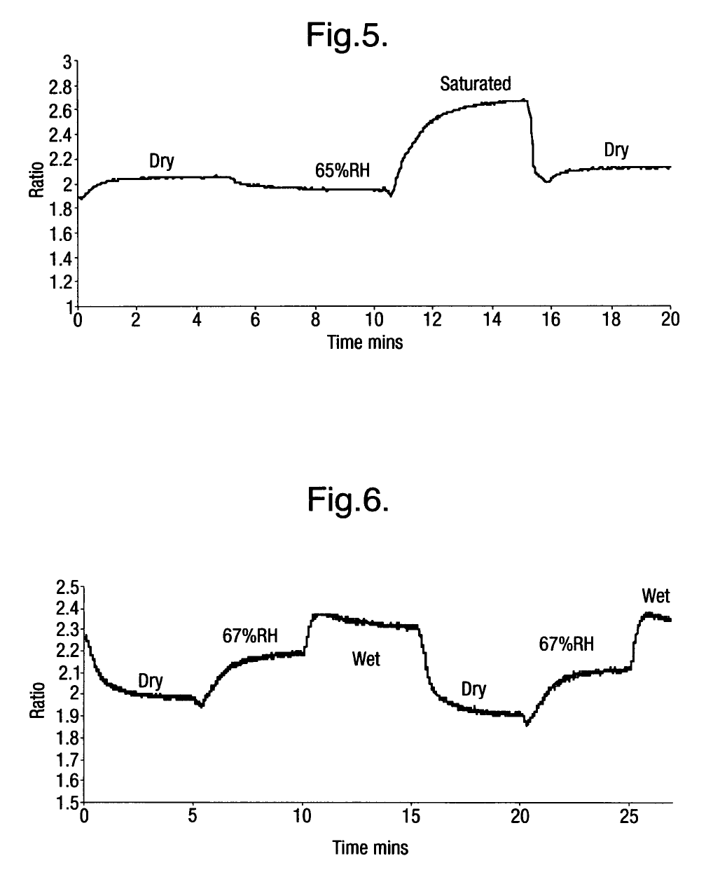

FIG. 5 represents a graph of the ratio of intensity variation of blue to red light measured employing fluorescein as indicator in alginin as host polymer in the sensing zone of the optical fibre according to FIG. 2;

FIG. 6 represents a graph of the ratio of intensity variation of blue to red light measured employing fluorescein as indicator in polyvinylalcohol as host polymer in the optical fibre according to FIG. 2;

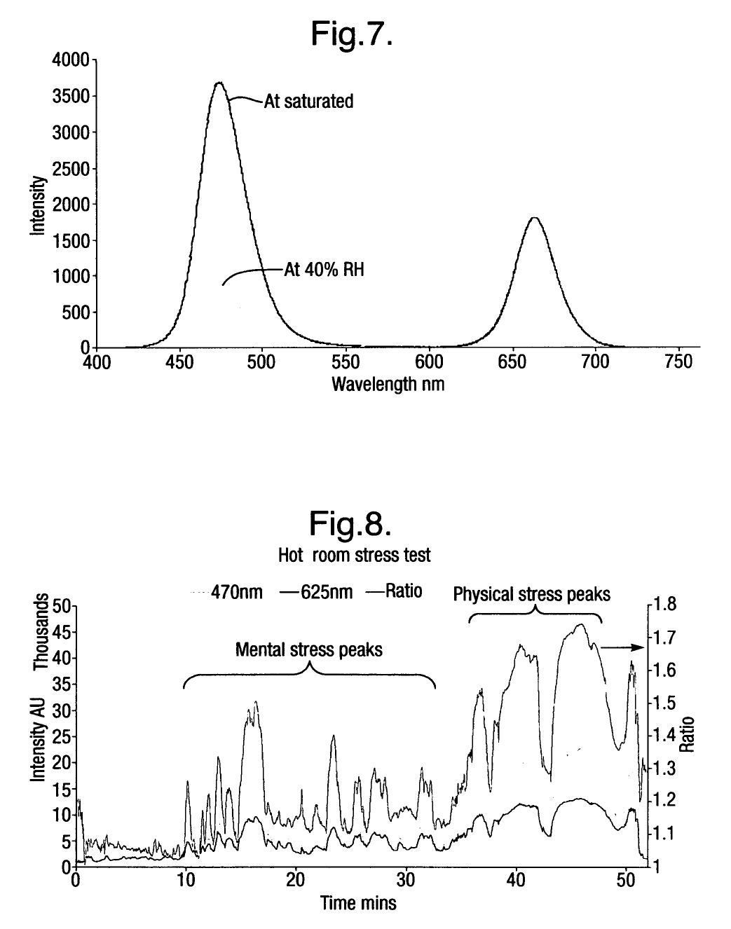

FIG. 7 represents a comparison of the spectra produced for red and blue light using fluorescein as indicator in polyvinylalcohol as host polymer, between saturated host and host that is at 40% RH;

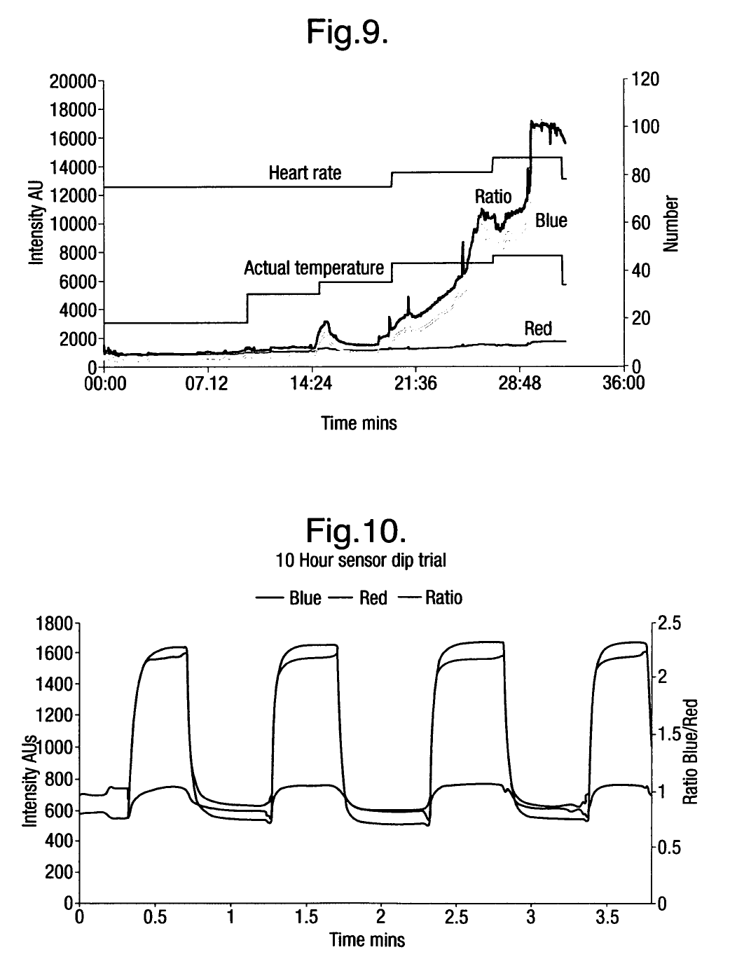

FIG. 8 represents the graphs of the intensity of light measured at 470 nm, 625 nm and their ratio FIG. 9 demonstrates sweat monitoring in a dry sauna using a sensor according to FIGS. 1 and 2.

FIG. 10 demonstrates the response to contact with water (representative of sweat) of a sensing system in which fluorescein isothiocyanate indicator is distributed and bound within a water-permeable host polymer that is a crosslinked copolymer, viz p(HEMA-co-MMA).

The control unit (1) illustrated in FIG. 1 and employed in generating the data illustrated in FIGS. 3 to 8 comprised a high intensity RGB tri-colour light emitting diode, (2), capable of emitting light at 470 nm, and at 625 nm, a broad spectrum photodiode (3) capable of detecting light at both 470 nm and 650 nm, an on/off switch (4), start and stop buttons respectively (5) and (6), a power source (7) a control microprocessor (8), an electronic memory (9) and a display panel (10).

FIG. 2 shows an optical fibre (11) extending from control unit (1) in a loop of length 200 cm, the optical fibre (11) having a core (12) made from polymethylmethacrylate, 1 mm diameter. The optical fibre (11) has a short sensing zone (14) (4 cm length) in which the core (12) is coated with a host polymer (15) in which fluorescein or sodium fluorescein was distributed as indicator. Outside the sensing zone (14), the core (12) is clad with fluorinated polymethylmethacrylate (13).

The sensing zone (14) was made by stripping away the cladding (13) from the zone using aqueous acetone and dipping the exposed core (12) in an aqueous solution of the host polymer (15) containing the indicator, removing the sensing zone from the solution and permitting the aqueous solvent to evaporate away.

In operation, the control unit (1) was switched on. The sensing zone (14) of the optical fibre for purposes of illustration of the capability of the sensor to indicate a wetness event was placed in a humidity-controlled chamber (not illustrated) that was capable of generating virtually saturated air (>95% RH). Data was generated using wavelength referencing by time division multiplexing. The microprocessor (8) controlled the firing of the LED (2) to alternately emit 470 nm and 625 nm light, and received and stored the sets of outputs from the photodiode (3) in the memory (9). One set of outputs represented the intensity of light at 470 nm and other at 625 nm respectively, from each of which background light intensity had been deducted. Thus, every cycle of measurements consisted of an output at 470 nm, a background reading, an output at 625 nm and a second background reading. Each of the two sets of outputs was averaged separately and the ratio of one set to the other calculated. The resultant ratio was also stored in the memory (9) and displayed on display panel (10).

It will recognised that in a variation to the microprocessor described in relation to schematic FIG. 1, the control functions, memory and microprocessor can be integrated into a microcontroller which stores the intensity data from the detector (including background readings) in its memory, and subsequently the stored data is downloaded into an external computer, e.g. through a USB port, which plots the background adjusted peak intensity at respectively 470 or 625 nm and calculates and plots their ratio.

The sensing zone of the sensor employed to generate the data summarised in FIG. 3 was made by dipping the exposed core (12) in a 5% by weight solution of methylcellulose in water containing 1 part by weight of fluorescein by 1000 parts of the host polymer.

The sensing zone of the sensor employed to generate the data summarised in FIG. 4 was made by dipping the exposed core (12) in a 5% by weight solution of chitosan in water containing 1 part by weight of fluorescein by 1000 parts of the host polymer.

The sensing zone of the sensor employed to generate the data summarised in FIG. 5 was made by dipping the exposed core (12) in a 5% by weight solution of alginin in water containing 1 part by weight of fluorescein by 1000 parts of the host polymer.

The sensing zone of the optical fibre employed to generate the data summarised in FIGS. 6 and 7 was made by dipping the exposed core (12) in an 8.5% by weight solution of methylcellulose in water containing 1 part by weight of fluorescein by 1000 parts of the host polymer.

FIGS. 3 to 7 showed that the sensor indicated clearly when the host polymer was wetted, i.e. at or close to 100% relative humidity, differentiating from when the atmosphere had even a high relative humidity such as 85% RH.

In FIG. 8, data presented was generated using a sensor in accordance with FIGS. 1 and 2 employing alginin as the host polymer for fluorescein in the sensing zone (14). The sensor was attached by tape (not illustrated) to the skin of a volunteer who was subjected to specified stresses over a period of about 50 minutes in a hot humid room. FIG. 7 illustrates not only the rapid response of the sensor to stresses, be they physical or emotional, but also its ability to recover quickly, enabling it to register a response to fresh stimuli after less than 2-3 minutes.

In FIG. 9, the data presented was generated using a sensor in accordance with FIGS. 1 and 2, employing in the sensing zone four thin layers of polyhydroxyethylmethacrylate as the host polymer doped with sodium fluorescein (6.64-5 molar) and applied from ethanolic solution and air dried. The sweat sensor was attached to and with its sensing zone within the armpit of a human subject at rest in a sauna, in which the ambient temperature was progressively raised. The absorption of both red (625 nm) and blue light (470 nm) was measured, their ratio calculated and all three are plotted.

It will be seen from FIG. 9 that sweating was detectable after about 20 minutes and became progressively more pronounced. The gradient of the sensor ratio became positive as droplets of sweat formed on the skin, particularly noticeable after 29 minutes. The gradient switch to positive at saturation for the p(HEMA)/fluorescein combination arose due to the optical effects.

The coated optical fibre sensor system whose sensitivity to water is demonstrated in FIG. 10 was made by first preparing a host copolymer, poly(HEMA-co-MMA) and thereafter twice coating the exposed polymethacrylate optical fibre with the copolymer whilst the latter is still liquid. A mixture of MMA (2000 μl) 2-(HEMA), (4000 μl), 3-aminopropyltriethoxy-siloxane, (500 μl), fluorescein isothiocyanate, 0.04 g added in small aliquots, and camphoquinone, 0.05 g added in small aliquots was then subjected to sonication at 80° C. for 3 days, mixed with an equal volume of ethanol and the resultant mixture was subjected to further sonication at room temperature for a day. A fraction of the blend was exposed to sunlight in a glass container under a nitrogen atmosphere until the blend had become a viscous liquid. The still fluid material was diluted 1:2 in ethoxyethanol and sonicated at 80° C. until clear.

Exposed pMMA optical fibre was dip coated and allowed to dry in a fume cupboard and the dipping and drying cycle repeated. The coated fibre was soaked in water buffered at pH9 to remove unbound indicator, and then twice in double distilled water and thereafter dried at 85° C. for a day.

The data in FIG. 10 shows the extremely rapid response to exposure to liquid water and drying of the detection system comprising fluorescein isothiocyanate bound (immobilised) in the crosslinked copolymer of HEMA and MMA. This system was particularly suitable for extended use.

1. A sensor for detecting sweat or other aqueous body fluids that is suitable for attachment to skin comprising a plastic optical fibre comprising a core and cladding, said core being in intimate contact at a first end with a light emitter and at a second end with a light detector, and said fibre having a sensing zone in which the cladding is replaced by a water-permeable translucent biocompatible host polymer containing dispersed therein a biocompatible indicator that varies the intensity of an optical signal at a selected wavelength depending on whether the indicator is wet or dry and means for attaching the sensing zone to skin.

2. A sensor according to claim 1 in which the plastic fibre core is polylmethylmethacrylate.

3. A sensor according to claim 1 in which the host polymer has a refractive index within 0.1 units of that of the plastic fibre core, and preferably within 0.08 units.

4. (canceled)

5. (canceled)

6. (canceled)

7. A sensor according to claim 1 in which the host polymer is selected from polyvinylalcohol, gelatine, alginin, chitosan, methylcellulose, polyhydroxyethylmethacrylate and a copolymer of hydroxyethylmethacrylate and an alkylmethacrylate.

8. A sensor according to claim 7 in which the host polymer is a copolymer of hydroxyethylmethacrylate and methylmethacrylate.

9. A sensor according to claim 7 in which the host polymer is polyhydroxyethylmethacrylate.

10. A sensor according to claim 1 in which the biocompatible indicator is fluorescein.

11. A sensor according to claim 1 in which the fluorescein is introduced as sodium fluorescein.

12. A sensor according to claim 10 in which the fluorescein is introduced as fluorescein isothiocyanate.

13. A sensor according to claim 12 in which the fluorescein isothiocyanate is immobilised in a host polymer, preferably comprising a copolymer of hydroxyethylmethacrylate and methylmethacrylate.

14. A sensor according to claim 1 in which the emitter emits light having a wavelength within the range of from 450 to 540 nm.

15. A sensor according to claim 14 in which the emitter emits light having a peak intensity in the range of from 465 to 475 nm.

16. A sensor according to claim 1 which additionally comprises an emitter of light having a wavelength that is different from the wavelength at which its intensity varies in response to whether the indicator is wet or dry.

17. A sensor according to claim 1 comprising a light emitting diode capable of generating light in at least two wavelengths, one of which two wavelengths is the wavelength that varies in intensity depending on whether the indicator is wet or dry and the second of the two wavelength has a different wavelength that does not vary depending on whether the indicator is wet or dry.

18. A sensor according to claim 16 in which one emission has a wavelength within the range of from 450 to 540 nm, preferably with a peak intensity of from 465 to 475 nm and a second emission has a wavelength of over 580 nm.

19. A sensor according to claim 1 comprising a broad spectrum detector that detects light from 450 nm to 540 nm and also over 580 nm.

20. A sensor according to claim 1 in which the detector generates an electronic signal in proportion to the intensity of light detected.

21. (canceled)

22. (canceled)

23. A sensor according to claim 1 which additionally comprises a clock, thereby enabling timing of an event comprising onset of sweating or other aqueous fluid discharge.

24. (canceled)

25. (canceled)

26. (canceled)

27. A process for the manufacture of a sensor for sweat or other aqueous liquid discharge onto skin having a light emitter, a light detector and a plastic optical fibre extending there between said fibre comprising a sensing zone, and a means for attaching a sensor zone to skin which process includes the step of forming the sensing zone by coating an exposed length of the plastic optical fibre core with a biocompatible water-permeable translucent polymer doped with a biocompatible indicator that varies the intensity of an optical signal at a selected wavelength depending on whether the indicator is wet or dry.

28. A method of assessing the effectiveness of an antiperspirant or other formulation for reducing or controlling sweating or other aqueous discharge onto skin, or of an ingredient therein which comprises measuring sweat or other discharge using a sensor according to claim 1 and comparing it with a reference formulation or ingredient.

29. (canceled)
